(19) United States
(12) Patent Application Publication
(10) Pub. No.: US 2005/0226591 A1
(43) Pub. Date: Oct. 13, 2005

(54) Microring and microdisk resonators for lasers fabricated on silicon wafers

(76) Inventors: Donald S. Gardner, Mountain View, CA (US); Mark L. Brongersma, Redwood City, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/121,582

(22) Filed: May 4, 2005

Related U.S. Application Data
(62) Division of application No. 10/749,986, filed on Dec. 31, 2003.

(51) Int. Cl. G02B 6/00

(52) U.S. Cl. 385/147

(57) ABSTRACT

Briefly, in accordance with one embodiment of the invention, a method is disclosed. The method includes forming a microresonator on a silicon substrate. The microresonator includes an annular structure to recirculate light at a desired wavelength.

This is a divisional application based on patent application Ser. No. 10/749,986, filed Dec. 31, 2003, entitled “Microring and Microdisk Resonators for Lasers Fabricated on Silicon Wafers”; and claims priority thereof.

### BACKGROUND OF THE INVENTION

To date, a microdisk or a microring microresonator has not been fabricated on silicon to provide light-emitting devices that are compatible with complementary metal-oxide semiconductor (CMOS) processes and that are monolithically fabricated on silicon substrates.

### DESCRIPTION OF THE DRAWING FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram of a microring microresonator disposed between two silicon dioxide waveguides on a silicon substrate in accordance with one embodiment of the present invention;

FIG. 2 is a diagram of a wet etched microdisk microresonator disposed between two silicon dioxide waveguides on a silicon substrate in accordance with one embodiment of the present invention;

FIG. 3 is a diagram of a dry etched microdisk microresonator disposed between two silicon dioxide waveguides on a silicon substrate in accordance with one embodiment of the present invention;

FIG. 4 is a diagram of simulations of light coupling from a waveguide to a microring resonator in accordance with an embodiment of the present invention;

FIG. 5 is a cross sectional diagram of a microring resonator with a waveguide disposed in position above the microring resonator for coupling in accordance with one embodiment of the present invention; and

FIG. 6 is a plot of photoluminescence from silicon nanocrystals without and with erbium in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

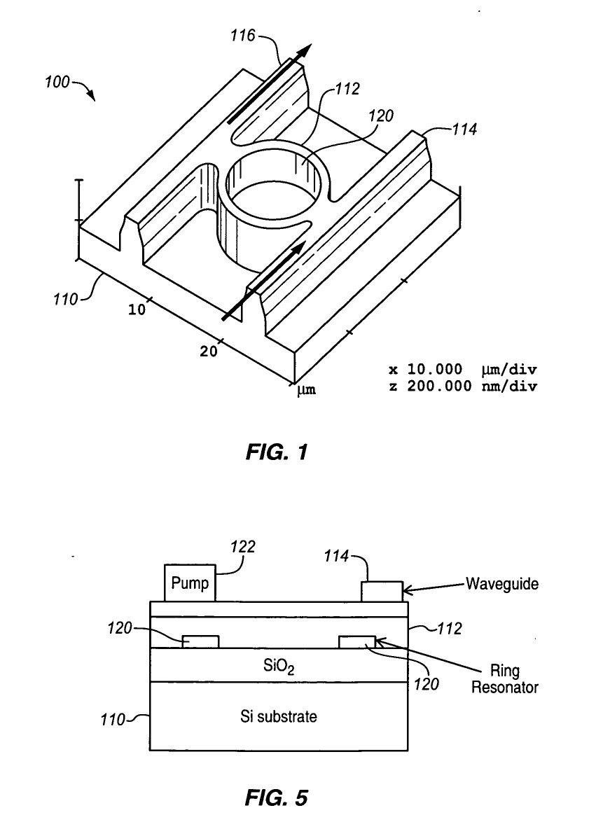

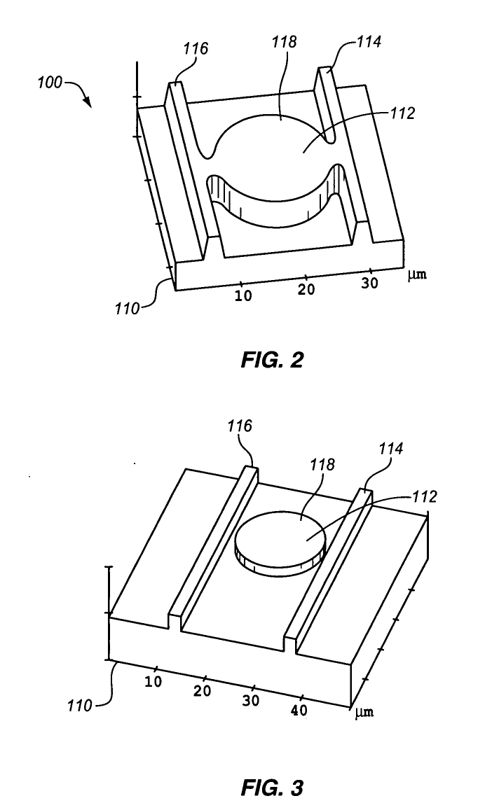

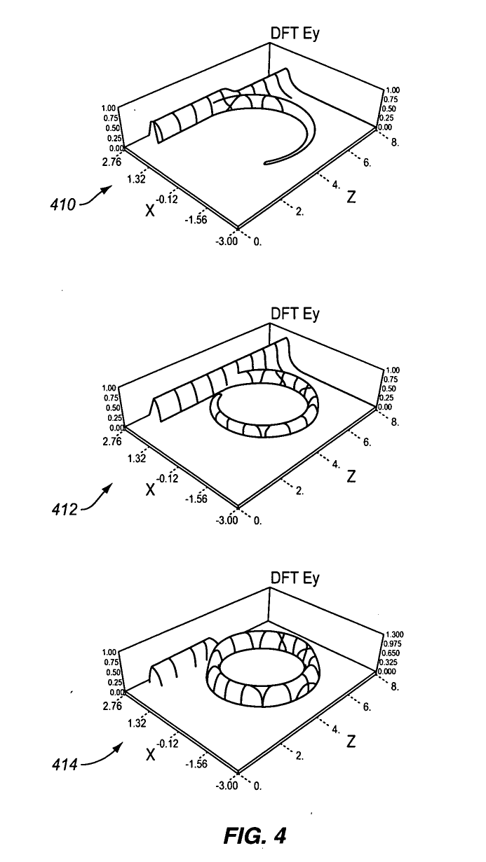

Referring now to FIG. 1, FIG. 2, and FIG. 3, diagrams of a microresonator disposed between two silicon dioxide (SiO₂) waveguides on a silicon substrate in accordance with one embodiment of the present invention will be discussed. In accordance with the present invention, a microresonator may be utilized in or as a device that produces light and may have the potential to generate coherent light such as laser light that is useful, for example, for optical communication between integrated circuits with an electronic device such as a computer, although the scope of the invention is not limited in this respect. Light emitting device 100 may comprise a microresonator 112 prepared using SiO₂ or Al-SiO_{X} deposited on a silicon substrate 110 that is typically utilized for CMOS circuits. The units of scale for FIG. 1, FIG. 2, and FIG. 3 may be 10 micrometers per division on horizontal axes (x and y) and may be 200 nanometers per division on the vertical axis (z), although the scope of the invention is not limited in this respect. Light emitting device 100 may be a combination of either a microring 120 microresonator 112 as shown in FIG. 1 or a microdisk 118 microresonator 112 as shown in FIG. 2 and FIG. 3 that is formed adjacent to a first waveguide 114 and a second waveguide 116 for coupling light into and out of microresonator 112. The microresonator 112 may confine light to a small volume by resonant recirculation and may be made out of a material with lower optical loss as illustrated, for example, in FIG. 3 and FIG. 4, although the scope of the invention is not limited in this respect.

In one embodiment of the invention, the circumference of microdisk 118 may be an integer multiple of the wavelength of the light wherein a whispering gallery mode resonance may be established. In an alternative embodiment of the invention, the length of the microring 120 may be an integer multiple of the wavelength of the desired light wherein resonance may be established. Pumping of microresonator 112 may be accomplished by either optically pumping with a light emitting diode (LED) from the top, for example with pump 122 shown in FIG. 5, or by coupling a light source from waveguide 114 or 116 to microresonator. Pumping may also be accomplished electrically for example by utilizing tunneling electrons through the dielectric material of microresonator 112. In such an embodiment, microresonator 112 may coax atoms or nanocrystals acting as quantum dots to emit spontaneous photons in a desired direction. Whispering gallery modes of silica and quartz microspheres may be utilized and may be dielectric spherical structures in which waves are confined by continuous total internal reflection. Such spheres may have lower-radial number modes that execute orbits near the surface of the sphere, although the scope of the invention is not limited in this respect.

Microresonator 112 may be fabricated by first depositing SiO₂ or AlSiO_{X} and then introducing excess silicon either during the deposition process or following it using ion implantation. The samples then may be patterned with round disks and rings using a mask with waveguides and microresonator microcavities. Subsequently, the oxide may be etched using either buffered oxide etching or by dry etching to result in microring 120 structure in FIG. 1 or microdisk 118 structures shown in FIG. 2 and FIG. 3. The samples may be annealed at 1100° C. in a furnace to form silicon nanocrystals. Microresonator 112 may be fabricated by forming silicon (Si) or silicon-germanium (SiGe) nanocrystals in a SiO₂, AlSiO_{X} or SiON matrix. The nanocrystals may be formed using a number of different techniques such as ion implantation. Ion implantation may also be done after creating a masking layer of photoresist so that silicon may be implanted into the oxide in a desired shape of the microresonators 112. In the event higher quality factors are desired, disks and rings can be annealed for example using a CO₂ laser that momentarily melts the surface, although the scope of the invention is not limited in this respect.

Microresonator 112 may provide a resonant frequency spectrum that is a function of the size of the microresonator 112. An ideal microresonator 112 may be defined as being able to confine light indefinitely without loss and would have resonant frequencies at precise values. The quality factor (Q factor) of microresonator 112 may describe deviation from an ideal microresonator. Higher quality factors may be obtained, for example, by minimizing surface roughness that may cause light scattering. Surface roughness may be a determining factor in waveguide losses, so the techniques utilized to reduce surface roughness in waveguides may be similarly applied to microresonator 112. With lower losses as obtained by reduced surface roughness, stimulated emission may be obtained as photons travel around the microresonator, and in one embodiment lasing may be obtained, although the scope of the invention is not limited in this respect. In one embodiment of the invention, stimulated emission may be obtained by utilizing silicon nanocrystals in SiO₂ for example by utilizing pulsed pumping, although the scope of the invention is not limited in this respect.

Referring now to FIG. 4, a diagram of simulations of light coupling from a waveguide to a microring resonator in accordance with an embodiment of the present invention will be discussed. The simulations 410, 412, and 414 of FIG. 4 show the field distribution after a discrete Fourier transform (DFT) for the center wavelength in a waveguide 114 adjacent to a microring 120 microresonator 112 as shown in FIG. 1. Simulation 410 does not contain an integer multiple of wavelengths around the ring for a wavelength of 1650 nanometers. Simulation 412 shows a near integer multiple of wavelengths in the ring for a wavelength of 1400 nanometers. Simulation 414 shows an integer multiple of wavelengths for a wavelength of 1413 nanometers. As can be seen in the simulation 414, the field strength is higher in microring 120 than in waveguide 114 because microring 120 is in a resonance condition. In accordance with one embodiment of the invention, microring 120 may be formed to have an overall length measured from the center of the waveguide portion of the microring that forms the ring structure, making the ring being an integer multiple of a desired wavelength. Such a length may be calculated as 2πR where R is the radius from the center of the ring structure to the center of the waveguide forming the ring structure, although the scope of the invention is not limited in this respect.

Referring now to FIG. 5, a cross sectional diagram of a microring resonator with a waveguide disposed in position above the microring resonator for coupling in accordance with one embodiment of the present invention will be discussed. As shown in FIG. 5, a microring 120 microresonator 112 is patterned on a silicon substrate 110 by forming nanocrystals in silicon dioxide. A waveguide 114 may be formed subsequent to forming the microring 120 microresonator 112 so that the waveguide may be disposed above microring 120. Forming the waveguide 114 to microring 120 in a vertical direction allows for greater control of the amount of coupling between waveguide 114 and microring 120 by adjusting the thickness of the films versus horizontal coupling where the coupling distance would be affected by the lithographic process. In one embodiment of the invention, the coupling distance between waveguide 114 and microring 120 may be approximately 250 nanometers, or within 250 nanometers, although the scope of the invention is not limited in this respect. Likewise, pump 122 to excite circulation of light in microring 120 may be disposed on top of microring 120, although the scope of the invention is not limited in this respect.

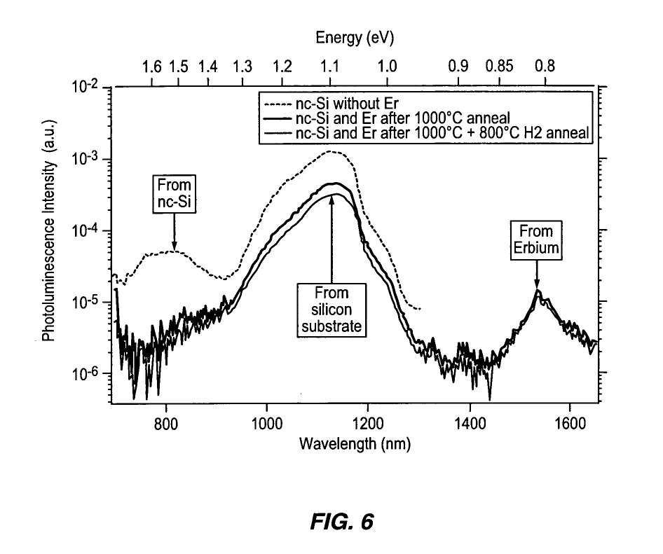

Referring now to FIG. 6, a plot of photoluminescence from silicon nanocrystals without and with erbium (Er) in accordance with an embodiment of the present invention will be discussed. FIG. 6 shows the photoluminescence emission from the silicon nanocrystals and from Erbium when Erbium is implanted into the vicinity of the nanocrystals. A photon may be absorbed by the nanocrystal causing the generation of an exciton within the nanocrystal. If an erbium ion is nearby the crystal, the exciton can recombine non-radiatively by exciting the erbium atom. As shown in FIG. 6, the addition of erbium may result in the silicon nanocrystals transferring their energy to the erbium rather than emitting light at 800 nanometers. The erbium then reemits the light at 1550 nanometers as shown in FIG. 6, although the scope of the invention is not limited in this respect. Thus, the silicon nanocrystals indirectly excite the erbium. Such excitation may occur via optically generated electron-hole pairs inside Si nanocrystals that recombine and transfer energy to the erbium ions.

The nanocrystals may have a pump absorption cross-section that is several orders of magnitude larger than the cross section for direct erbium excitation. In addition, the erbium absorption cross-section for the optical signal is also increased by the Si nanocrystals. Finally, silicon nanocrystals can be excited in a much broader wavelength range, for example less than 900 nanometers, than erbium atoms. The microresonator 112 therefore may be pumped with a lower power broadband light source such as an LED either from the top surface or via waveguide 114 or 116, although the scope of the invention is not limited in this respect.

In one embodiment of the invention, for long-haul fiber communications, the wavelength of the optical signal may be 1.5 micrometer. The optical interconnection lengths within a computer, however, may not be long, so in such an embodiment the wavelength does not have to be 1.5 micrometers, the wavelength at which adsorption from water is at a minimum, nor 1.3 micrometers, the wavelength where dispersion is zero. Erbium produces light at 1.5 micrometers. In an alternative embodiment, ytterbium (Yb) may be utilized to produce light at 1.0 micrometers, a wavelength that may be detected using silicon-germanium (SiGe) photodetectors, although the scope of the invention is not limited in this respect.

In one embodiment of the invention, confinement may be obtained by creating a structure that can then be overgrown with a lower refractive index material. Such a device may be made using standard CMOS techniques such as chemical vapor deposition (CVD), sputtering, or thermal oxidation for the SiO₂ and SiO_{X} layers and ion implantation or cosputtering for the erbium ions. The optical cavity can be electrically modulated using metal deposited on top or below the waveguide. Materials that adjust the barrier height may also be utilized for adjusting the electron tunneling, although the scope of the invention is not limited in this respect. The silicon nanocrystals may be fabricated using a thin layer of SiO_{X} deposited between two layers of SiO₂ on a silicon substrate. Such a technique may provide control of the size of the nanocrystals and the distribution of sizes resulting in a manufacturable device.

Although the invention has been described with a certain degree of particularity, it should be recognized that elements thereof may be altered by persons skilled in the art without departing from the spirit and scope of the invention. It is believed that the microring and microdisk resonators for lasers fabricated on silicon wafers of the present invention and many of its attendant advantages will be understood by the forgoing description, and it will be apparent that various changes may be made in the form, construction and arrangement of the components thereof without departing from the scope and spirit of the invention or without sacrificing all of its material advantages, the form herein before described being merely an explanatory embodiment thereof, and further without providing substantial change thereto. It is the intention of the claims to encompass and include such changes.

1. A method, comprising:
forming a microresonator on a silicon substrate, the microresonator having an annular structure to recirculate light at a desired wavelength.

2. A method as claimed in claim 1, wherein said forming includes forming the annular structure to be a ring.

3. A method as claimed in claim 1, wherein said forming includes forming the annular structure to be a disk.

4. A method as claimed in claim 1, wherein said forming includes patterning matrix materials on the substrate using lithography.

5. A method as claimed in claim 1, wherein said forming includes using a mask to prevent implantation of silicon in a region outside the annular structure.

6. A method as claimed in claim 1, further comprising annealing the annular structure.

7. A method as claimed in claim 1, further comprising annealing the annular structure using laser annealing.

8. A method as claimed in claim 1, wherein said forming includes fabricating silicon or silicon-germanium nanocrystals near erbium by chemical vapor deposition.

9. A method as claimed in claim 1, further comprising forming at least one waveguide proximate to said microresonator wherein light may be coupled between said microresonator and said waveguide.

10. A method as claimed in claim 1, wherein said forming includes using an optically active element having an excited state lifetime at a wavelength detectable by a photodetector.

11. A method as claimed in claim 9, further comprising forming a pump proximate to said microresonator and said waveguide to excite circulation of light in said microresonator.

12. A method as claimed in claim 11, further comprising said pump tunneling current through silicon dioxide to form electron-hole pairs in the silicon or silicon-germanium nanocrystals in the silicon dioxide.

13. A method as claimed in claim 2, wherein the ring includes a length from a center of the ring to a center of a waveguide that forms the ring being proportional to an integer multiple of a desired wavelength.

14. A method as claimed in claim 3, wherein the disk includes a perimeter being an integer multiple of a wavelength.
